(19) United States
(12) Patent Application Publication
(10) Pub. No.: US 2009/0043594 A1
(43) Pub. Date: Feb. 12, 2009

(54) Method and system for shortage deduction processing

(75) Inventor: Denys Tseng, Pasadena, CA (US)

Correspondence Address: Ficode, Inc., 840 East Green Street, Unit 111, Pasadena, CA, 91101, US

(73) Assignee: Denys Tseng, Pasadena, CA (US)

(21) Appl. No.: 11/836,781

(22) Filed: Aug. 10, 2007

(51) Int. Cl. G06Q 30/00

(52) U.S. Cl. 705/1

(57) ABSTRACT

There is disclosed a method and system for automatically processing of shortage deduction transactions utilizing Radio Frequency Identification (RFID) for goods sold. A shortage deduction takes place, in connection with transactions involving one selling company and one buying company, when the buying company remits less than the pre-agreed rate citing reasons related to shipping or transportation issues for withholding part or all of the payment. The processing may include data matching and proactively tracing invoice transactions that are identified as shortage upon comparing the Electronic Product Code (EPC) information. If mismatch occurs during transportation a claim is filed with the freight company. If mismatch occurs after goods are received at the retailer's store(s) a declination will be issued. Deductions are also declined when EPC comparisons made on shipments that the deductions reference do not result in mismatch.

### FIELD OF THE INVENTION

The present invention generally relates to a method and system of automated processing of deduction transactions involving a selling company and at least one buying company, and more particularly, the utilization of the Electronic Product Code to effectively and proactively process shortage deductions.

### BACKGROUND OF THE INVENTION

Products are distributed by the manufactures to their customers who in turn sell them to the consumers. Manufactures invoice their customers at pre-agreed rates. In many cases, however, the customer remits less than the invoiced amount, citing some reason for withholding part of the payment. Amounts so withheld are called deductions and shortage deductions, a shipping related issue, is considered one of the most common reasons and time consuming to resolve.

Deductions drain time and resources from marketing, sales, credit, collections, accounts receivables, customer service and distribution personnel as they research and resolve deductions. The problem is as widespread across industries as it is within a company. Time and resources spent on resolving deductions could otherwise be spent on more value added activities.

For the most part, companies currently employ a manual and paper based resolution process which in turn cripples them from handling increasingly large volumes of transactions. Some companies even implement automatic write off thresholds to make time to process high dollar deductions. While some companies may utilize software applications to assist them manage the mounting deduction workload, those applications lack integration into supply chain or distribution systems to effectively resolve and further speed up the resolution on shortage deductions. Again, such type of deduction makes up the majority of the deduction problem.

A more effective system and method for deduction processing that fully integrates into the accounting, distribution and order management systems is desirable. Not only it can accelerate and streamline the processing of shortage deductions, it further allows companies to proactively identify them and begin processing prior to deductions taking place through the utilization of RFID information.

### OBJECTIVE OF THE INVENTION

A first objective of the invention is to fully automate, currently manual process, deduction transactions involving a selling company and at least one buying company. Another objective is to provide a deduction management system, a software application, which allows collaboration between accounting, logistics and customer service departments within the selling company's organization. Another objective is to leverage RFID technology in shortage deduction resolution process that allows selling company to proactively identify shortage deductions before they occur.

### SUMMARY OF THE INVENTION

In accordance with the present invention, a method and system for automatically processing and managing shortage deduction transactions involving a selling company and at least a selling company. Deduction transactions are associated with sales transactions where customer remits less than the pre-agreed amount. It provides an automatic and systematic way to resolve shortage deductions problems and allows multiple departments—accounting, logistics and customer service—to work in collaboration. The method and system disclosed herein not only allows a common platform for the selling company to function in unison throughout the shortage deduction resolution lifecycle it also allows the selling company to identify real problems the resulted in deductions.

According to one embodiment, a method is provided for automating the deduction resolution process. One step is initiating the resolution process in one of five ways: indexing imaged debit memo(s) into the system; querying accounts receivable system for any invoices that are paid short; manually entering ad hoc deduction information into the system; querying any unmatched EPC in a shipment; or querying accounts receivable system for any invoice(s) that satisfy a predetermined number of days unpaid after the ship date. Another step is collecting data from accounts receivable system, order management system, and distribution system including the EPC information. Another step is obtaining signature proofs of delivery from the freight company. Another step is performing EPC data matching. Another step is determining whether there was an exception for the shipment in the logistics task by data comparison. Another step is providing deduction resolution base on the result of the previous step.

According to another embodiment, a system is provided for automating deduction resolution process. The system includes at least one workflow engine operable to transition work task between work steps, at least one RFID information management system operable to receive and match EPC information, and a relational database management system.

### BRIEF DESCRIPTION OF THE DRAWINGS

FIG. 1 is a process flow diagram of the present invention.

FIG. 2 is a process flow diagram of workflow initiation of the present invention.

FIG. 3 is a process flow diagram of data acquisition of the present invention.

FIG. 4 is a process flow diagram of the EPC data acquisition and matching of the present invention.

### DETAIL DESCRIPTION OF THE DRAWINGS

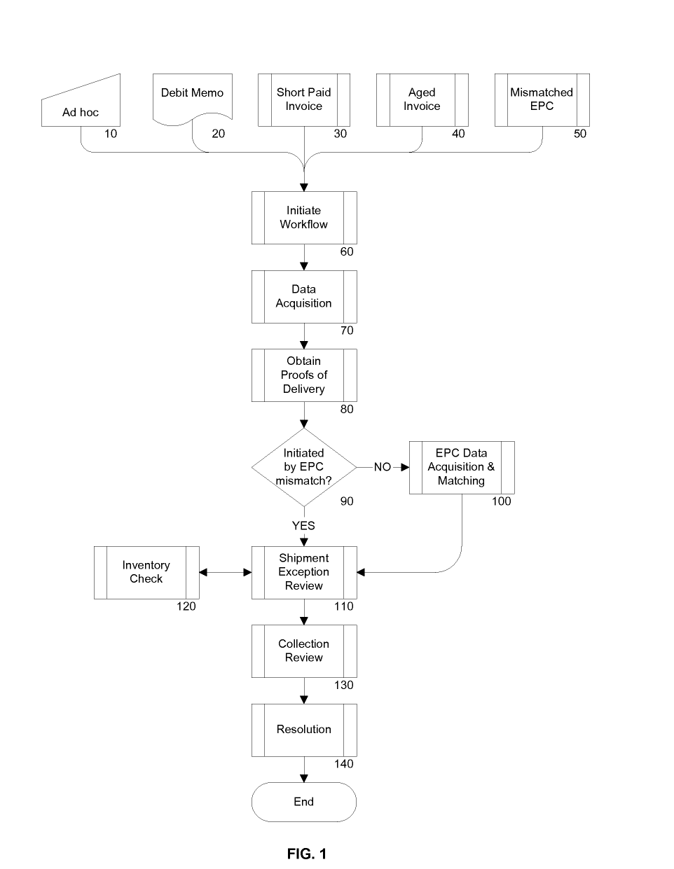

FIG. 1 provides a process flow diagram of a preferred embodiment of the present invention. The process of shortage deduction resolution begins with a trigger event that, upon validation, initiates the workflow process. There are five trigger events: Ad hoc 10, Debit Memo 20, Short Paid Invoice 30, Aged Invoice 40, and Mismatched EPC 50. A collection agent may trigger the Ad hoc 10 event by manually entering a set of basic information that includes invoice number, deduction number, deduction amount, deduction date, and the reason of the deduction. A Debit Memo 20 event is triggered when a debit memo, which can be in the form of a letter, facsimile transmittal or digitized image, is indexed electronically (OCR) or manually into the system. The fields indexed are: invoice number, deduction number, deduction amount, deduction date, and reason for deduction. Both Short Paid Invoice 30 and Aged Invoice 40 events may be either pushed or pulled mechanisms. Lists of invoice or deduction transactions are pulled from the accounts receivable system at regular intervals that are scheduled on an enterprise scheduling system. The pushed mechanism accepts either a list of invoice numbers or deduction transactions from the accounts receivable system. Regardless of the mechanism used to trigger the events. Short Paid Invoice 30 triggers are usually the result of customer remits invoices through electronic lock boxes and when some or all invoices in the remittance advice are paid short. Aged invoices 40 are traced through the shortage deduction process to proactively collect shipping related proofs to prevent loss on shortage deductions that may arise in the future due to carrier's statute of limitation. EPC Mismatch 50 is another proactive approach to identify shortage deductions before they occur.

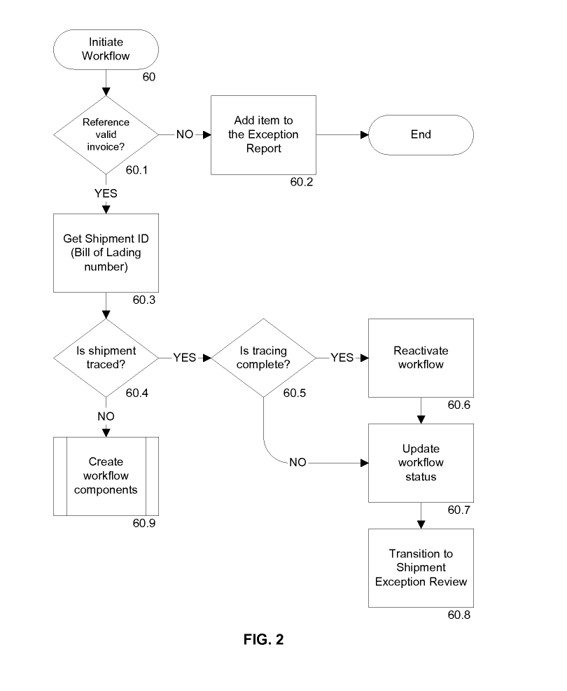

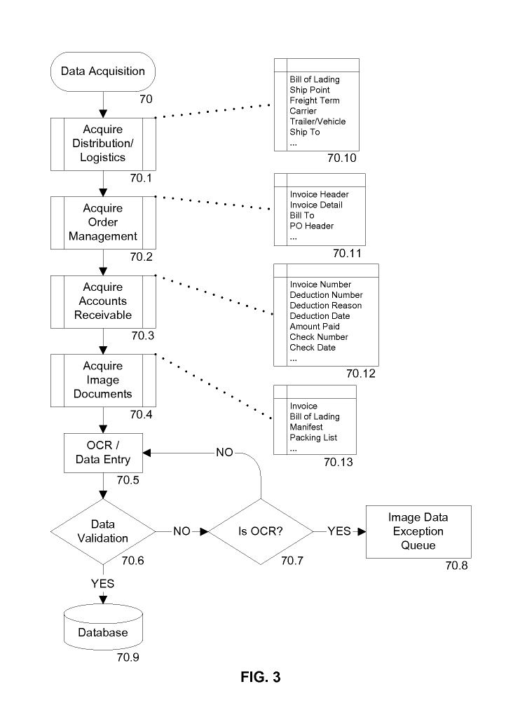

Once triggered, the Initiate Workflow process 60, FIG. 2, assembles necessary workflow components that allows seamless transitions between departments responsible for either gathering proofs, perform collection duties or customer service, within the manufacturer's organization during the shortage deduction resolution process. Data acquisition process 70, FIG. 3, gathers data necessary for the resolution process and provides basic data sets that are required for the rules engine to automatically determine shipment exception.

Proof of Delivery is an integral and important piece of information that generally provides the basis of the resolution decision. A proof of Delivery usually state the number of items a consignee receives and signed for. When the number matches the number of items shipped and invoiced by the manufacturer the shortage deduction will be declined. The process of Obtain Proofs of Delivery 80 involves retrieving from the image database of previously collected signature proofs from the carrier, connecting directly to carrier sites via either HTTP or web services to access and store proof of delivery documents, or generate a Proof of Delivery request to be submitted to the carrier.

EPC data further improves the accuracy of the resolution decision. Electronic Product Code (EPC) is a coding scheme created as a method of tracking goods using the Radio Frequency Identification (RFID) technology. With the implementation of RFID tag readers at stores and receiving docks such Wal-Mart and Target, manufacturers can now gain insight as to where the products have been after they are shipped. Using the EPC data made available to the manufacture by the retailer, the EPC Data Matching 100 process can proactively initiate possible shortage deduction tracking on invoices containing mismatched EPC before deductions occur.

The Carrier EPC discussed herein is not intended to be limiting to this invention. It is exemplary with the additional carrier data set can further improve the EPC matching process. In the case where Carrier EPC data set is not available, the matching process is operable to perform matching using EPC data sets from manufacturer and the retailer.

Shipment Exception Review 110 uses a rules based engine that determines whether a shipment exception has occurred according to the information gathered from steps 70 through 100. A claim is filed against the freight carrier if it the system determines that the carrier is liable for the shortage or sometimes damaged product. The workflow remains in the wait status until the claim is paid in full buy the carrier or additional proof is provided. There are occasions, when necessary, the process step will also include Inventory Check 120 based on the business rules. The Shipment Exception Review is monitored by the manufacturer's logistics department.

The Collection Review 130 also uses a rules based engine to make the final resolution decision based on the disposition of the Shipment Exception Review. If the decision from the Shipment Exception Review indicates false, a declination will be the decision of this work step otherwise a credit will be issued to the customer. This process step is monitored by the manufacturer's accounting department.

Based on the decision given in the Collection Review, the Resolution 140 process will either prepare a Letter of Declination, indicates the shortage deduction has no merit and flags accounts receivable system to further collect on the balance. If it is deemed to be accurate, a status update will be sent to the accounts receivable system to adjust the balance and issue a credit. Supporting documentation including Proofs of Delivery will be sent along with the Letter of Declination to the customer.

FIG. 2 illustrates a detail process flow of workflow initiation 60. As show, the process first checks whether the trigger event in an embodiment of the present invention references a valid invoice number. If it does not, the deduction is added to the exception report step 60.2 and the flow ends without further processing. In the case, a trigger event references a valid invoice number the Get Shipment ID will fetch the Bill of Lading number from the distribution system. It will then validate whether the shipment is already traced in the system. If the result is negative, workflow components are created in the Create workflow components step 60.9. Otherwise, the shipment is traced or currently being tracked in the system. If the tracing is completed on the shipment the deduction references, the workflow of the tracing of the shipment is reactivated 60.6. Otherwise, the shipment is actively traced, a status is given to the workflow at step 60.7 and then transitions to the Shipment Exception Review 110. A newly created workflow associated to the shortage deduction is transitioned to the Data Acquisition work step 70.

FIG. 3 shows the process flow involving data acquisition 70. The data sets acquired at the completion of this process are: shipping information which comprises bill of lading, ship point, freight term, carrier code, trailer or vehicle identification and ship to (consignee); order information that comprises invoice header, invoice detail, bill to and purchase order header information; accounts receivable information that comprises invoice number, deduction number, deduction reason, deduction date, deduction amount, amount paid, check number and check date; and image documents that may include invoice, bill of lading, shipping manifest, and packing list. Validations are done on image documentations acquired. If the data of the fields indexed are valid the data will be stored in the database, otherwise the images will be transitioned in to the Image Data Exception Queue 70.8 where it awaits for the data to be corrected.

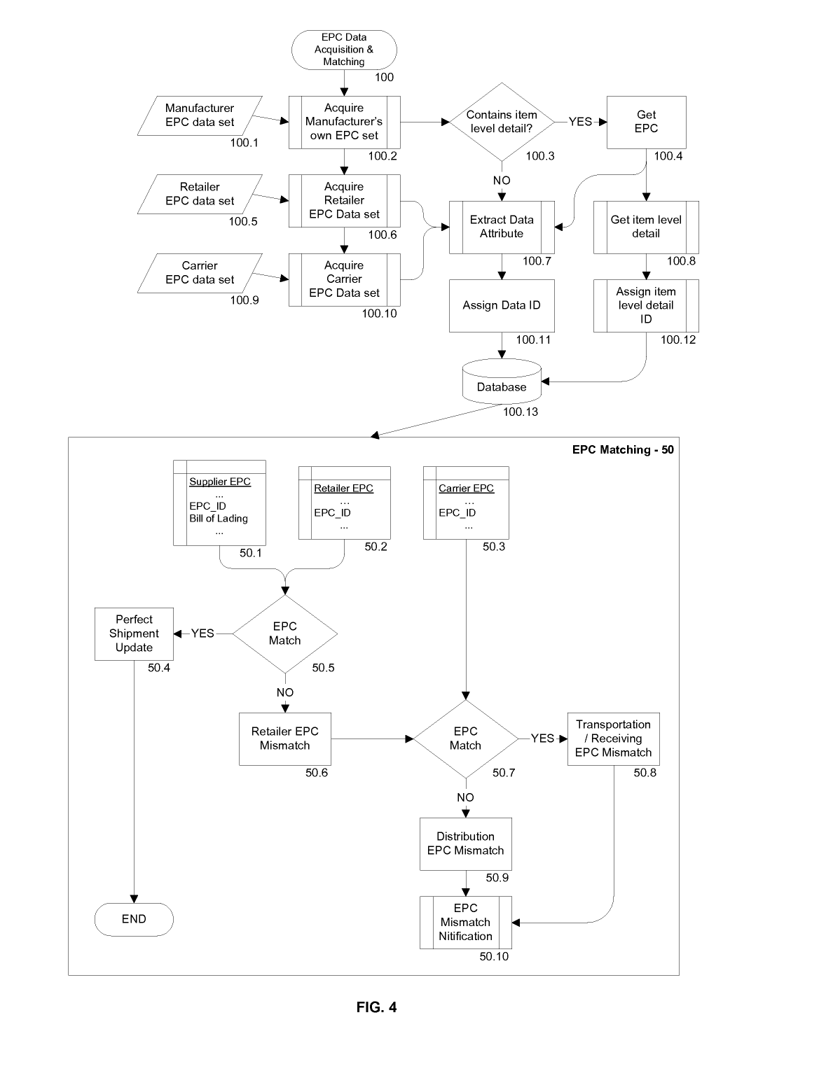

FIG. 4 details the process steps for EPC Data Acquisition and Matching 100. The process first fetches manufacturer's own EPC data set from its distribution system to be used as the basis of comparison against retailer's EPC data set and carrier EPC data set when available. During the EPC data acquisitions, attribute values are extracted 100.7 from EPC then stored in the database 100.13. The EPC matching process begins by matching EPC identifiers in the manufacturer's EPC data in a shipment against EPC data set published by the retailer. When all EPC identifiers match in a shipment the shipment will be flagged as a perfect shipment in 80.4 and the process completes. If a mismatch situation occurs during the matching of data sets between manufacturer and retail EPC, the Retailer EPC Mismatch work step 50.6 inserts a mismatch flag to the shipment and moves on to the next work step. Depending on the availability of the carrier EPC data set, the process either continues EPC matching or ends. When manufacturer's EPC data set matches carrier's EPC data set but does not match against retailer's EPC data set, a flag is given to the shipment indicating transportation or receiving exception had occurred. If carrier's EPC data does not contain some or all of the EPC identifier in a shipment, it is likely an exception had occurred during shipping at manufacturer's distribution center and the shipment is also flagged.

What is claimed is:

1. A method and system for automatically processing of deduction transactions between a selling company and one or more buying companies. The method for automatically processing deduction transactions comprising the steps of: (a) initiating the deduction process workflow by one of five ways: (a1) by an agent manually entering ad hoc deduction information; (a2) by indexing imaged debit memo(s); (a3) by systematically querying accounts receivable system for any invoices that are paid short; (a4) by systematically querying accounts receivable system for any invoice(s) that satisfy a predetermined number of days unpaid after the ship date; or (a5) by the RFID information management module raising any unmatched EPC in a shipment; (b) crating and assembling workflow components; (c) acquiring data and bill of lading information having at least one entry, the data acquisition comprises distribution information, invoice header information, invoice line item information, customer purchase order information, and image documents; (d) obtain signature proofs of delivery from freight companies; (e) performing EPC data acquisition and matching; (f) routing the deduction information to shipment exception review task for disposition according to predetermined rule set; (g) routing the deduction information to accounting task for resolution base on the disposition given by the previous work step; and (h) declining with a letter of declination sent to the buying company or (i) adjusting the accounting balance for the deduction that is deemed to have merit.

2. The method of claim 1, wherein the deduction information comprises a deduction number, amount, date, and at least one invoice number.

3. The method of claim 1, wherein the deduction is entered manually through an interface to trigger the tracing of the shortage deduction resolution process.

4. The method of claim 1, wherein the debit memo is received by the selling company from the buying company which indicates buying company's intent to deduct on an invoice or a plurality of invoices. The debit memo may be a facsimile transmittal or in the form of a letter.

5. The method of claim 1, wherein a debit memo may be an imaged document electronically transmitted to the selling company which then indexed either manually or electronically that triggers the shortage deduction resolution process.

6. The method of claim 1, wherein the short paid invoice is a situation when the buying company remits less than the pre-agreed rate for an invoice. When it occurs the invoice is flag and initiates the shortage deduction resolution process.

7. The method of claim 1, wherein a aged invoice or a plurality of invoices are identified according to the predetermined number of days an invoice is allowed to remain unpaid and upon the expiration the invoice is traced through the shortage deduction resolution process. This preemptive measure allows the selling company to obtain proofs of delivery proactively prior to the statute of limitation put in place by the freight companies.

8. The method of claim 1, wherein the mismatched EPC is the result from the matching of EPC data in a shipment by comparing the set of EPC data recorded by the buying company against the set of EPC records the selling company captured at the time of shipping. Any shipment contains mismatched EPC data is traced though the shortage deduction resolution process.

9. The method of claim 1, wherein a shipment is identified by a bill of lading number. A shipment is considered as a unit of work in the shortage deduction resolution workflow process. A shipment may relate to one or many invoices. An invoice may relate to one or many deductions. A purchase order may relate to one or many shipments.

10. The method of claim 1, wherein the bill of lading information comprises a bill of lading number, a progressive (PRO) number a standard carrier alpha code (SCAC), at least one invoice number, and at least one tracking number.

11. The method of claim 1, wherein the invoice header information comprises an invoice number, a customer identifier, a customer bill to identifier, an invoice date, an invoice amount, and purchase order (PO) number.

12. The method of claim 1, wherein the Electronic Product Code (EPC) is related to a shipment by a bill of lading number.

13. The method of claim 1, wherein the signature proofs of delivery is obtained through freight company's exposed web services portals.

14. The method of claim 1, wherein the signature proofs of delivery is obtained by systematically interrogating freight company's website containing the signature image.

15. The method of claim 1, wherein the signature proofs of delivery is obtained by facsimile transmittal from the freight company to the selling company.

16. The method of claim 1, wherein the predetermined rule comprises of making shipment exception decisions by comparing items invoiced against items received by the buying company. The matching may also include EPC matching and extracting receiving information of proofs of delivery.

17. The method of claim 1, wherein the shipment exception review task is a work step in the deduction transaction processing which determines whether there was an exception to the shipment. A disposition is given as the result of the review.

18. The method of claim 1, wherein the collection review task is a work step in the deduction transaction processing which determines whether the selling company should honor the deduction or issue a declination. The decision is generally derived from the disposition given in the shipment exception review.

19. The method of claim 1, wherein the deduction workflow comprises: receiving deductions and debit memos; initiating the deduction processing; collecting bill of lading data; collecting invoice data; collecting invoice line item data; collecting shipping data which includes carrier and EPC information; collecting accounts receivable data; collecting image documents; obtaining proofs of delivery; matching EPC data sets; shipment exception review; collection review; and resolution.

20. The method of claim 1, wherein a system for automatically processing of deduction transactions comprises at least one workflow engine that acts as the information routing mechanism and maintains the states throughout the lifecycle of the deduction processing and tracking; at least one RFID information management module operable to receive and match EPC information from at least one buying company corresponding to at least one invoice which the deduction is referenced; at least one database, a data storage for the system claimed herein; a deduction information module to process information and provide resolution for the deduction claimed by the buying company.
